(19) United States
(12) Patent Application Publication
(10) Pub. No.: US 2006/0167389 A1
(43) Pub. Date: Jul. 27, 2006

(54) Control arrangements for therapeutic inflatable cell apparatus

(76) Inventors: John James Henry Evans, Barton on Sea (GB); Christopher Peter Evans, Lymington (GB)

Correspondence Address: BAKER & BOTTS, 30 ROCKEFELLER PLAZA, 44TH FLOOR, NEW YORK, NY, 10112, US

(21) Appl. No.: 11/264,711

(22) Filed: Nov. 1, 2005

Related U.S. Application Data
(63) Continuation-in-part of application No. 10/263,792, filed on Oct. 3, 2002, now abandoned.

(51) Int. Cl. A61H 23/04

(52) U.S. Cl. 601/152; 601/150

(57) ABSTRACT

A valve arrangement for a pump, the pump being suitable for urging fluid into therapeutic inflatable cell apparatus, the valve arrangement comprising a rotatable valve member provided with at least one fluid passageway, the rotatable valve member being adapted to be rotated to predetermined angular positions so as to control fluid quantity in the therapeutic inflatable cell apparatus. The valve arrangement further comprises a static valve member, provided with at least one fluid passageway which is adapted to be communicable with the inflatable cell apparatus and the rotatable valve member being arranged to be rotatable with respect to the static valve member into a position in which said at least one fluid passageway of the rotatable valve member is in fluid communication with the at least one fluid passageway of the static valve member.

### CROSS-REFERENCE TO RELATED APPLICATIONS

This application is a continuation-in-part of U.S. patent application Ser. No. 10/263,972, filed Oct. 3, 2002 which is incorporated by reference in its entirety herein, and from which priority is claimed.

The present invention relates to control arrangements for therapeutic inflatable cell apparatus and in particular, but not exclusively, to control arrangements for pressure therapy products which comprise an inflatable cell for pressure area care, including but not limited to air filled mattresses, garments and cushions. Such products provide pressure relief on patient tissue.

Such products generally comprise a plurality of inflatable cells which can be inflated/deflated to produce a therapeutic effect. Control of such products is conventionally effected by a pneumatic pump unit.

It is an object of the present invention to provide improved control of pressure therapy products.

According to a first aspect of the invention there is provided a valve arrangement for a pump, the pump being suitable for urging fluid into therapeutic inflatable cell apparatus, the valve arrangement comprising a rotatable valve member, said rotatable valve member being provided with at least one fluid passageway and the rotatable valve member being adapted to be rotated to predetermined angular positions so as to control fluid quantity in the therapeutic inflatable cell apparatus.

Preferably where the inflatable cell apparatus comprises a plurality of cells the predetermined angular positions are indexed so that the cells can be selectively inflated.

Preferably the valve arrangement further comprises a static valve member, said static valve member being provided with at least one fluid passageway which is adapted to be communicable with the inflatable cell apparatus and the rotatable valve member being arranged to be rotatable with respect to the static valve member. Most preferably the inflatable valve member is adapted to be rotated into a position in which said at least one fluid passageway of the rotatable valve member is in fluid communication with the at least one fluid passageway of the static valve member.

The rotatable valve member is desirably adapted to be rotated to predetermined angular positions so as to control fluid flow to and from the inflatable cell apparatus.

The rotatable valve member is desirably provided with at least one fluid passageway for inflation of at least part of the inflatable cell apparatus and with at least one fluid passageway for deflation of at least part of the inflatable cell apparatus, and in use the rotatable valve member can be rotated to predetermined angular positions to effect at least one of inflation and deflation of the apparatus.

In a highly preferred embodiment the rotatable valve member is rotatable with respect to the static valve member so as to determine whether a fluid passageway of the static valve member is brought into fluid communication with either an inflation passageway or a deflation passageway of the rotatable valve member.

Preferably the static valve member comprises a plurality of fluid passageways, each fluid passageway being associated with a respective cell of an inflatable cell apparatus.

In a preferred embodiment the static valve member is provided with at least two sets of a plurality of fluid passageways, each set of passageways being adapted to be associated with a respective inflatable cell apparatus.

In preferred embodiments, said fluid passageways of the rotatable valve member and the static valve member extend from one side of the respective valve member to an opposite side of the respective valve member.

Channels are desirably formed in an outer surface in the static valve member, the channels being in fluid communication with fluid passageways of the static valve member, and said channels extending substantially laterally of the fluid passageways.

At least two fluid passageways may be fluidically connected by a channel.

A control arrangement is preferably provided which is adapted to adjust the angular position of the rotatable valve member to a desired angular position in response to a first signal relating to a current angular position, and in response to a second signal relating to angular displacement of the rotatable valve member during movement thereof to the desired angular position.

The control arrangement preferably comprises a pressure sensor and an optical wheel with slots at predefined angular increments associated with the rotatable valve member and, in use, the sensor being operative to sense the index features.

The control arrangement preferably comprises a data processor in the form of a programmable integrated circuit (PIC) device, rotation of the rotatable valve member being controlled by the PIC device in response to the first and second signals.

According to a second aspect of the invention there is provided a method of controlling fluid quantity in a therapeutic inflatable cell apparatus, the method comprising rotating a rotatable valve member to predetermined angular positions so as to permit at least one of inflation of the inflatable cell apparatus and deflation of the inflatable cell apparatus.

Preferably the rotatable valve member is caused to be rotated in a predetermined sequence. Preferably the predetermined sequence causes at least one part of the therapeutic inflatable cell apparatus to be inflated and then deflated.

The method most desirably comprises rotating the rotatable valve member to bring at least one fluid passageway of the rotatable valve member into fluid communication with the inflatable cell apparatus.

Preferably a set of control instructions causes the pump apparatus to control fluid quantity in a respective inflatable cell apparatus in a predetermined manner.

Conveniently where the data storage device comprises RAM (Random Access Memory) a user may input a desired set of control instructions to be stored.

According to one aspect of the invention there is provided a method of controlling fluid quantity in therapeutic inflatable cell apparatus comprising measuring fluid pressure in at least part of the therapeutic inflatable cell apparatus and controlling the fluid quantity in response to pressure which has been measured.

According to a further aspect of the invention there is provided a control assembly for a therapeutic inflatable cell apparatus, the assembly comprising a pressure sensor, a data processor and a fluid control assembly, the data processor being configured to receive a feedback signal from the pressure sensor which is representative of a measurement of fluid pressure in a therapeutic inflatable cell apparatus, and said data processor being further configured to emit a control signal in response to the feedback signal, the control signal being sent to the fluid control assembly which is operative to control fluid quantity in the therapeutic cell apparatus.

Various embodiments of the invention will now be described, by way of example only, with reference to the accompanying drawings in which:

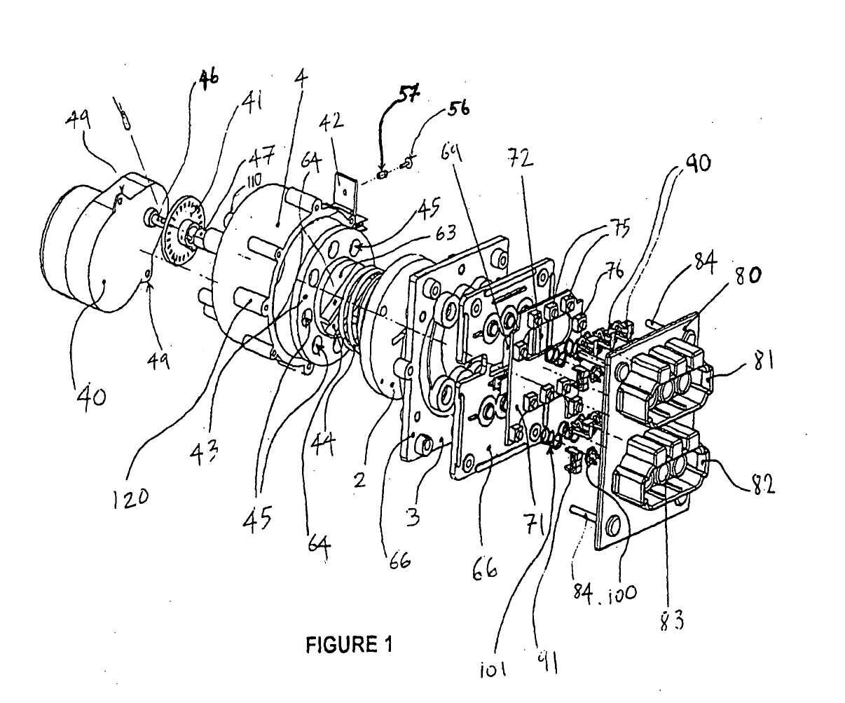

FIG. 1 is an exploded front isometric view of part of pneumatic pump assembly in accordance with the invention,

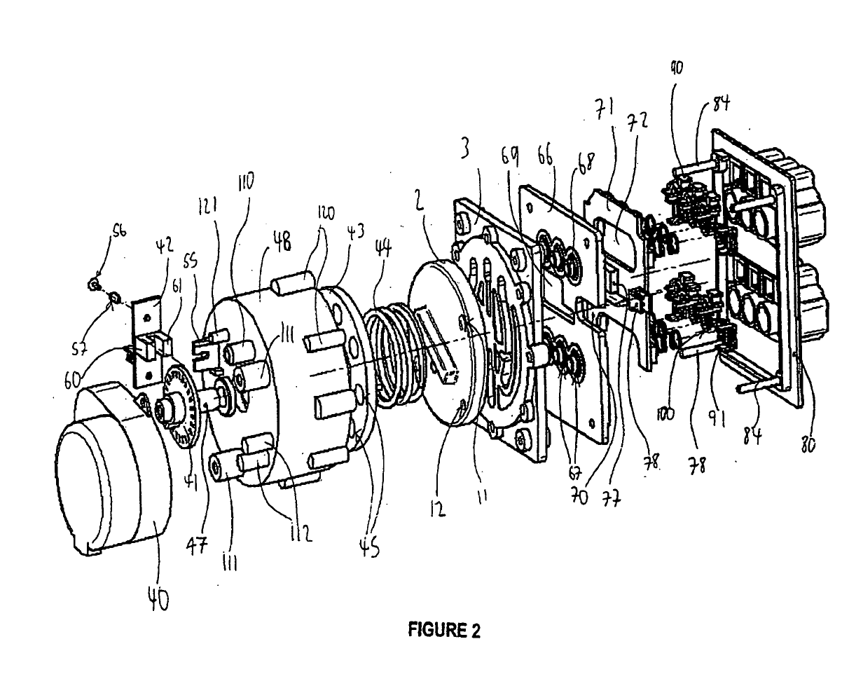

FIG. 2 is an exploded rear view of the part of the pneumatic pump assembly shown in FIG. 1,

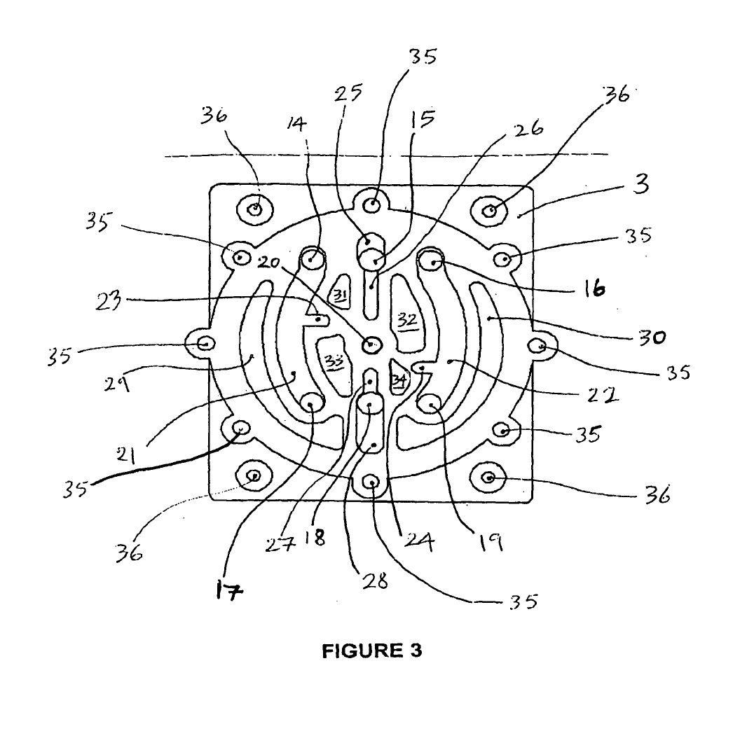

FIG. 3 is a rear elevation of the static valve member shown in FIGS. 1 and 2,

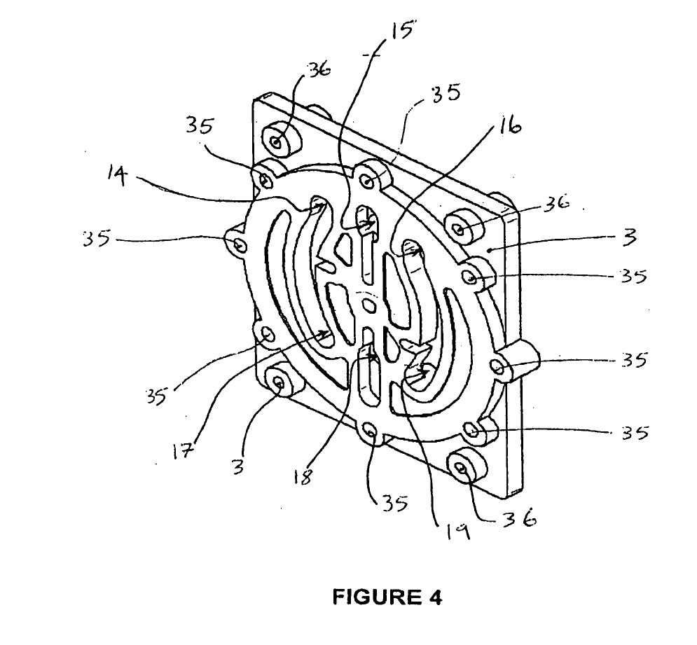

FIG. 4 is a rear isometric view of the static valve member shown in FIG. 3,

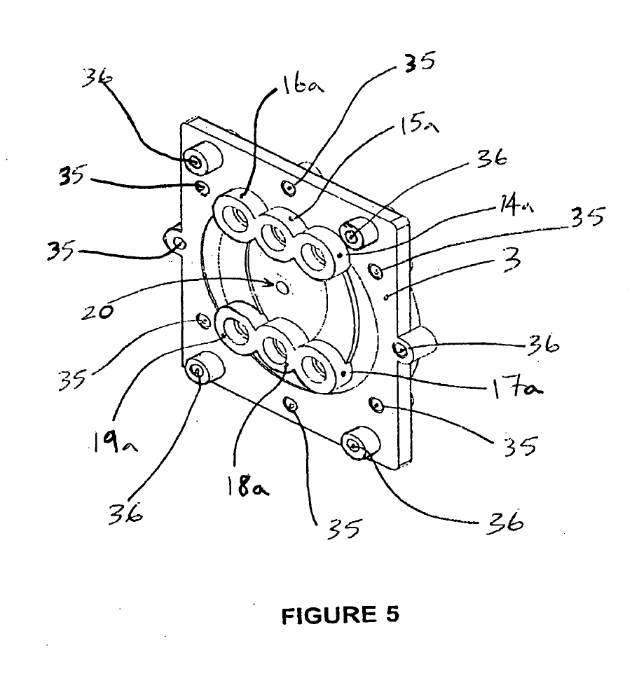

FIG. 5 is a front isometric view of the static valve member shown in FIGS. 3 and 4,

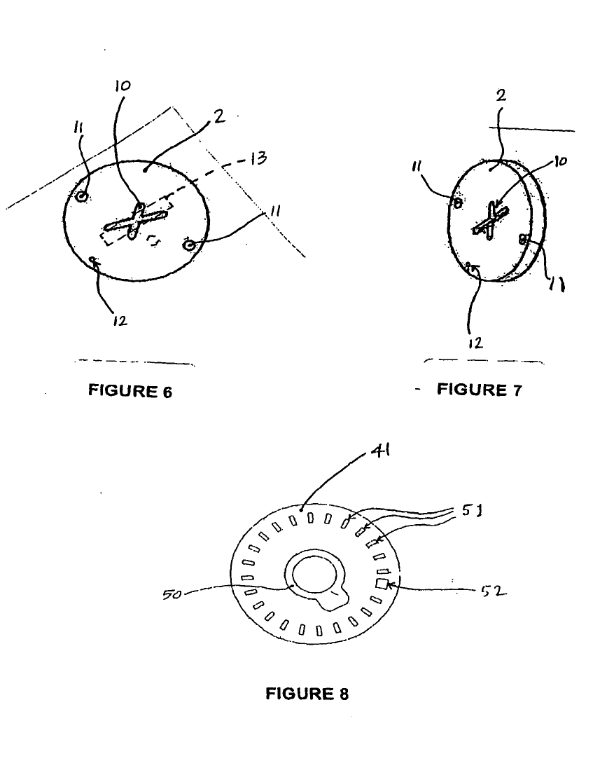

FIG. 6 is a front elevation of the rotatable valve member shown in FIGS. 1 and 2,

FIG. 7 is a front isometric view of the rotatable valve member shown in FIG. 6,

FIG. 8 is a front elevation of the optical disc shown in FIGS. 1 and 2,

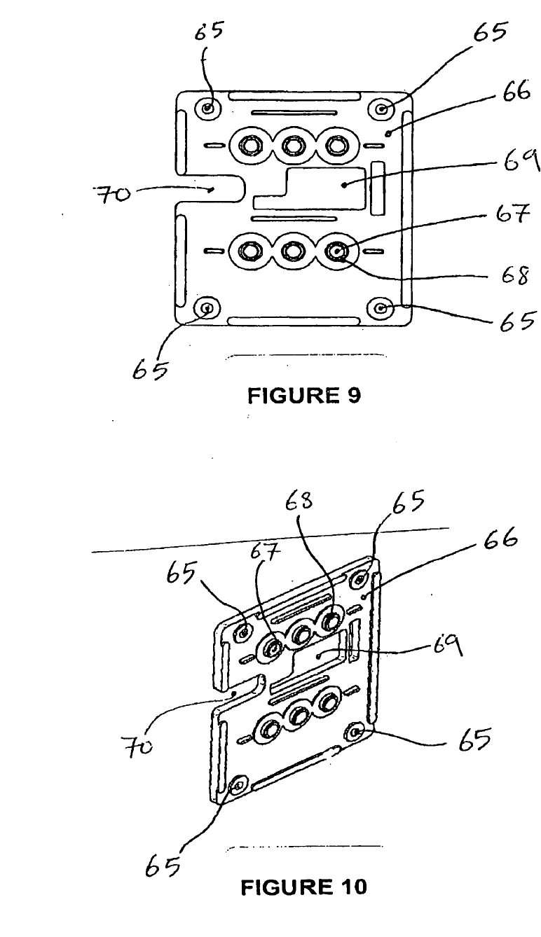

FIG. 9 is a front elevation of the intermediate plate shown in FIGS. 1 and 2,

FIG. 10 is a front isometric view of the intermediate plate shown in FIG. 9,

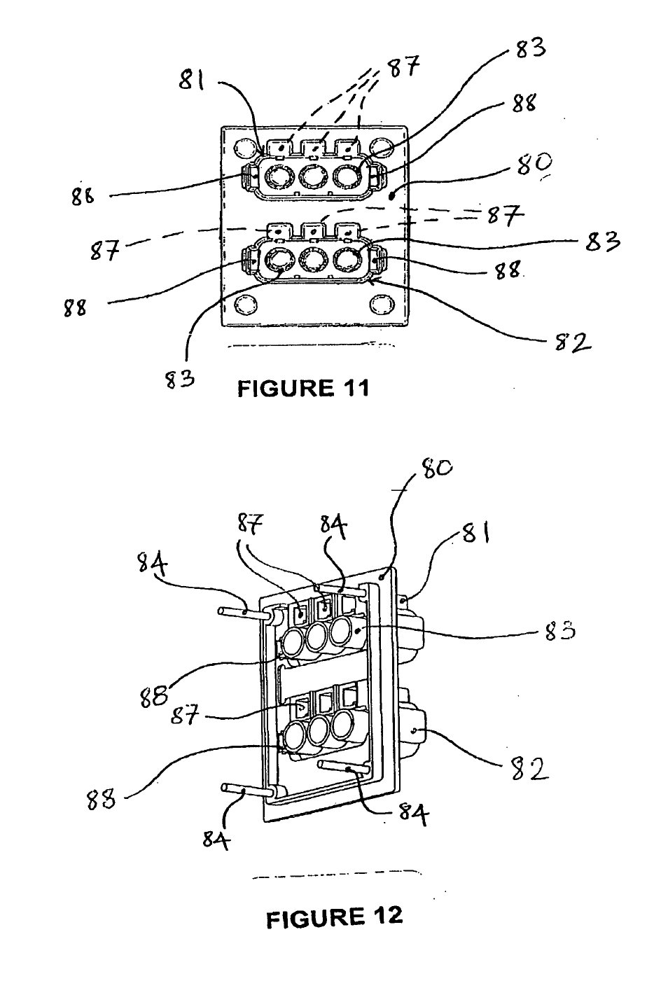

FIG. 11 is a front elevation of the connector plate shown in FIGS. 1 and 2,

FIG. 12 is a rear isometric view of the connector plate shown in FIG. 11,

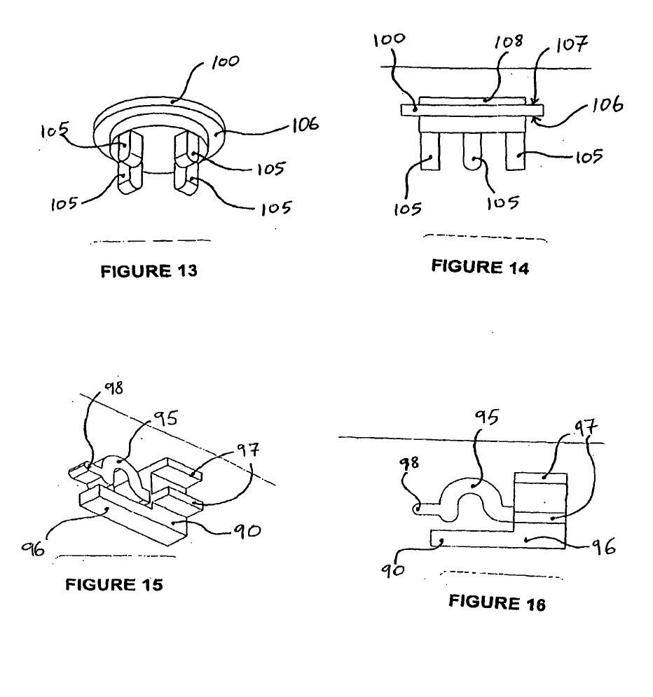

FIG. 13 is an isometric view of a non-return valve shown in FIGS. 1 and 2,

FIG. 14 is a side elevation of the non-return valve shown in FIG. 13,

FIG. 15 is an isometric view of a portable pump assembly,

FIG. 16 is a flow diagram of process steps to determine connection status of a therapy product,

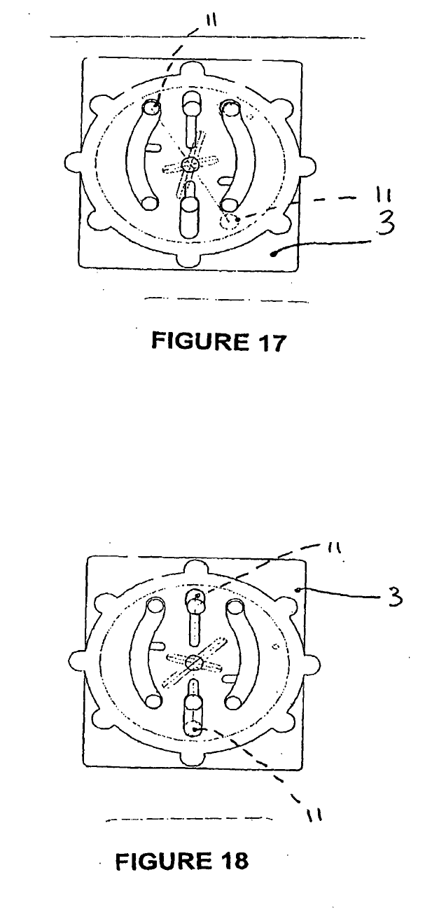

FIG. 17 is a rear elevation of the static valve member onto which the outline of the rotatable valve member in a first position has been superimposed,

FIG. 18 is similar to FIG. 17 with the rotatable valve member shown in a second position,

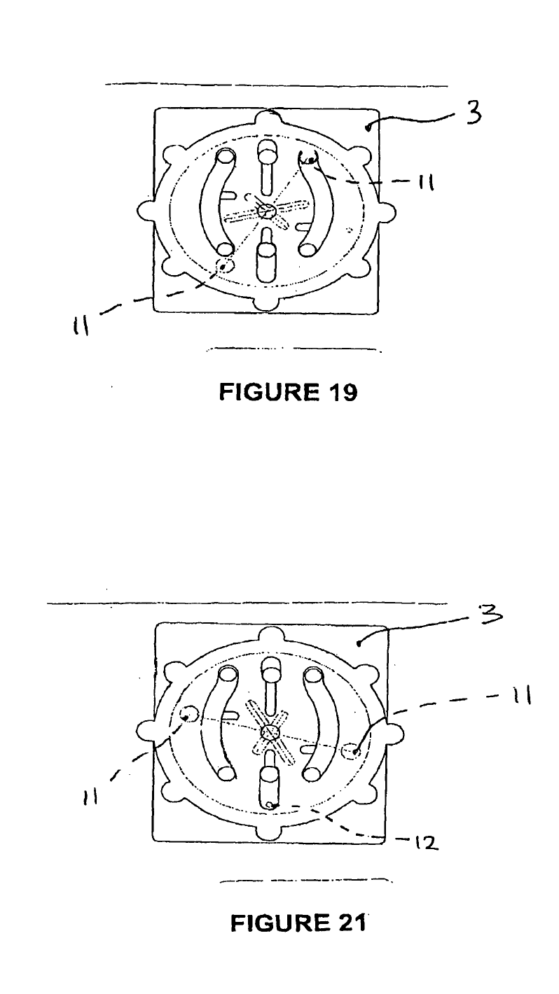

FIG. 19 is similar to FIGS. 17 and 18 with the rotatable valve member in a third position,

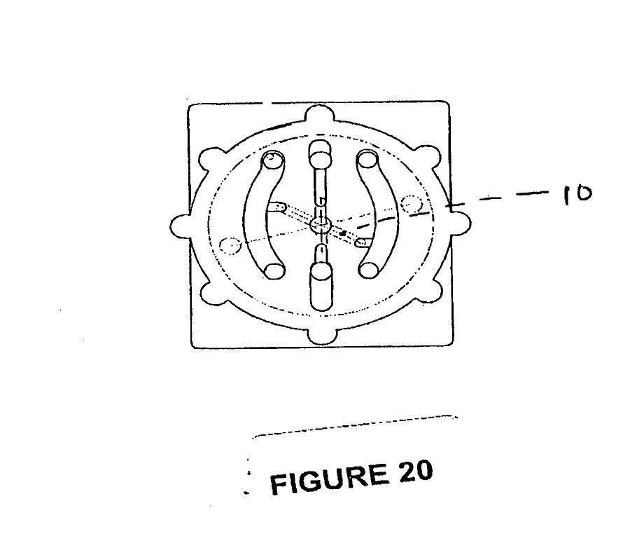

FIG. 20 is similar to FIGS. 17, 18 and 19 with the rotatable valve member shown in a fourth position,

FIG. 21 is similar to FIGS. 17, 18, 19 and 20 with the rotatable valve member shown in a fifth position,

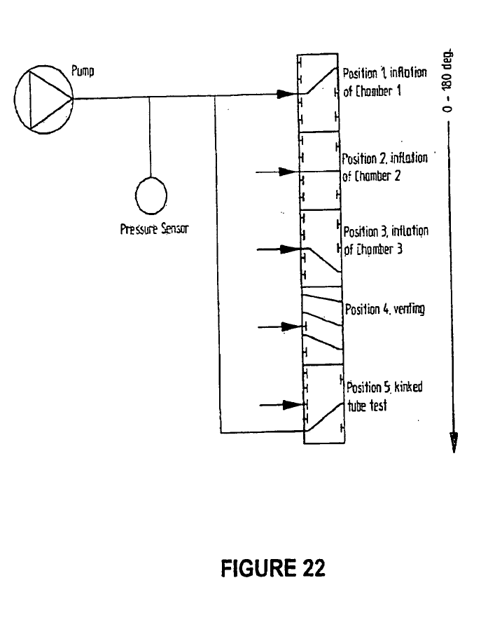

FIG. 22 is a schematic representation of the various predetermined angular positions of the rotatable valve member,

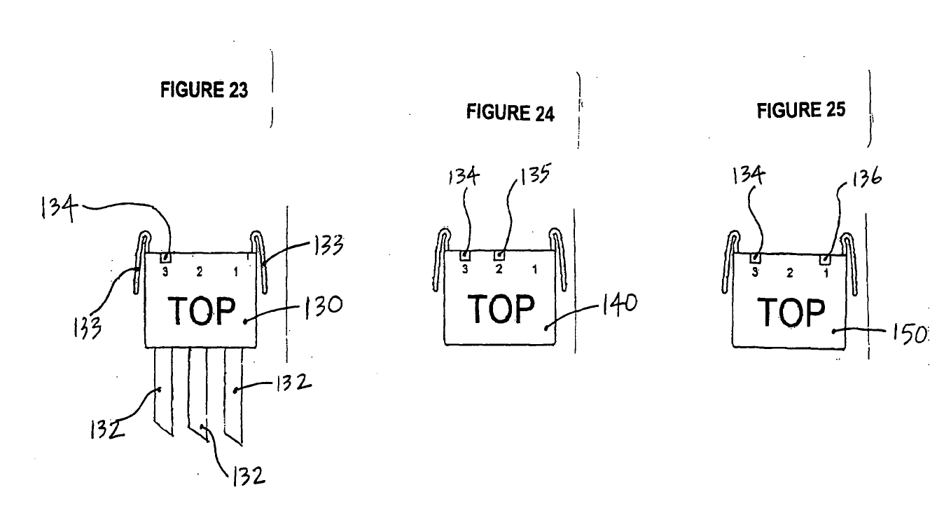

FIG. 23 is a plan view of a plug of a first pressure therapy garment,

FIG. 24 is a (somewhat schematic) cross-section of the components shown in FIGS. 1 and 2 in an assembled state in which one plug has been inserted into one of the sockets of the connector plate,

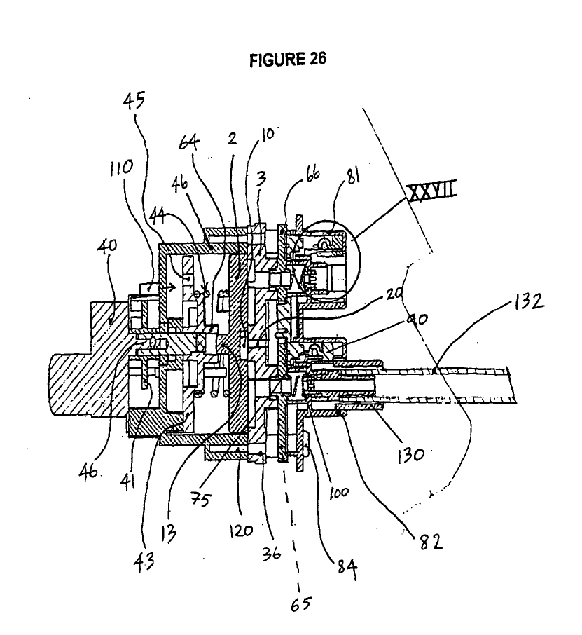

FIG. 25 is an enlarged view of a socket indicated by the enclosed region of FIG. 26, and

FIG. 26 is a block diagram of various control components of the pneumatic pump assembly.

With reference to FIGS. 1 and 2 there are shown various components of part of a pneumatic pump assembly 300 (as shown in FIG. 15) for pressure therapy products as hereinbefore discussed, said components forming a valve and a connector arrangement 1 as will now be further described. The pneumatic pump assembly 300 is a portable unit which is provided with a control panel comprising user input means including a key pad and a display screen, generally shown at 301.

The valve arrangement comprises a rotatable valve member 2, a static valve member 3, the rotatable valve member 2 being arranged to be rotatable with respect to the static valve member 3.

With further reference to FIGS. 6 and 7 the rotatable valve member 2 is of disc-like form and is provided with a ‘blind’ recess 10 of substantially skewed X-shape which is formed in the front surface thereof. The valve member 2 further comprises two through-holes 11 forming fluid passageways which are angularly spaced by 180° about the centre point of the valve member 2.

A third though-hole 12 is provided in the rotatable valve member 2 of which the angular separation from each of the holes 11 is 75° in each case.

The rearward surface of the rotatable valve member 2 is provided with rib 13 which extends in a direction which is substantially parallel to the diameter of the valve member.

With reference in particular to FIGS. 3, 4 and 5 the static valve member 3 is essentially of plate like form and is provided with a first set of horizontally aligned ports 14, 15 and 16 and a second set of horizontally aligned ports 17, 18 and 19, said ports providing fluid passageways. A port 20 is also provided in the static valve member 3 which is located substantially centrally of said valve member.

As seen best in FIGS. 5 and 6 channels 21 and 22, which are of substantially arcuate outline, provide fluid communication between ports 14 and 17, and ports 16 and 19 respectively. The channels 21 and 22 are provided with branch channel positions 23 and 24 respectively which extend substantially horizontally towards the vertical axis of the static valve member 3.

The ports 15 and 18 which are located centrally of each set of ports are each provided with upper and lower channel portions which are in fluid communication with the respective port. The port 15 is provided with an upper channel portion 25 and a lower channel portion 26, and the port 18 being provided with upper channel portion 27 and lower channel portion 28.

The rearward face of the static valve member 3 is also provided with a plurality of pressure relief recesses 31, 32, 33 and 34.

Turning to FIG. 5 showing the front face of the static valve member 6 each port 14, 15, 16, 17, 18 and 19 there is an associated outwardly extending annular wall 14a, 15a, 16a, 17a, 18a and 19a respectively.

Equally angularly spaced around the ports 14, 15, 16, 17, 18, 19 and 20 and arranged in a circular formation, a first set of eight attachment through-holes 35 are provided. The static valve member 3 is also provided with a second set of four attachment through-holes 36 which are located towards the corners of the valve member 3.

The assembly further comprises a motor 40, an optical disc 41, a sensor 42, a transmission disc 43 and a spring 44.

The motor 40 comprises an output shaft portion 46 onto which is rotatably mounted the optical disc 41. The shaft portion 46 is received in a collar 47 and is fast with the optical disc 41. The collar 47 passes through the disc 41 and through two sleeves 50 which are provided on opposite sides of the disc 41. The shaft portion 46 extends through an aperture in cylindrical housing 48 and the distal end of said collar 47 is fixedly attached to the rearward face of the transmission disc 43.

The optical disc 41 is provided with twenty three slots 51 and one slot 52, the slots 51 and 52 are angularly spaced around the disc 41 and the slot 52 being slightly wider than the slots 52.

A sensor device 42 is attached to bracket 55 by way of a two-piece fastener arrangement shown at 56 and 57. The sensor device may generally be described as a phototransistor device which comprises two limbs 60 and 61 which are spaced such that in use they flank the optical disc 41. The limb 60 is provided with an inwardly directed light emitting device (not shown) and the limb 61 is provided with a light sensor (not shown) which is directly opposite the light emitting device.

The transmission disc 43 is provided with eight equally angularly spaced ports 45 and comprises a locating formation 63 on the front face thereof. The locating formation 63 comprises two spaced walls 64 which are adapted to receive the rib 13 of the rotatable valve member 2.

The spring 44 is adapted to fit over the locating formation 63 and the rib 13 and so be interposed between the transmission disc 43 and the rotatable valve member 2.

Located adjacent to the front face of the static valve member 3 there is provided an intermediate plate 66. The intermediate plate 66 is provided with two sets of three ports 67 which are arranged to correspond with the arrangement of the ports 14, 15, 16, 17, 18 and 19 of the static valve member 3. Each port 67 comprises an outwardly extending conduit portion 68 on front and rear faces of the intermediate plate 66.

The intermediate plate 66 is provided with two cut-outs 69 and 70 which are located generally between the two sets of ports 67. The intermediate plate is further provided with four attachment holes 73 which are located towards each corner of the plate.

Moving further forward there is provided a plate 71. The plate 71 is provided with two cut-outs 72 and 73 which are dimensioned to accommodate the conduit ports 68 of the intermediate plate 66.

The connector plate 80 comprises two socket formations 81 and 82 which are each adapted to receive a respective plug 130, as shown in FIG. 23, of a pressure therapy product.

The rearward ends of connection conduits 83 are each provided with a non-return or shut-off valve arrangement which comprises a valve plate 100 and a spring 101. The valve plates 100 each comprise four guide limbs 105 which are configured to be received in a respective conduit 83. (Valve plates 100 are omitted from FIG. 2 for reasons of clarity.)

A front facing annular shoulder 106 is provided around the guide limbs 105 and is axially spaced from the bases thereof. In use the shoulder 106 receives an o-ring seal (omitted from FIGS. 13 and 14).

The valve plate 100 is provided on the rear facing surface thereof with an annular shoulder 107 which is adapted to locate one end of the respective spring 101.

FIGS. 24 and 25 show the components of FIGS. 1 and 2 in an assembled state. As is evident fasteners 84 are passed through aligned attachment holes 65, 36 of the intermediate plate 66 and the static valve member 3 respectively and into respective blind bores 120 of the housing 48. The transmission disc, the spring 44 and the rotatable valve member 2 are thus contained within the housing 48. The action of the spring 44 is to cause the rotatable valve member 2 to resiliently bear against the rearward face of the static valve member 3 and be in fluid sealing engagement therewith.

In use the apparatus operates as follows. A pressure therapy product (for example a leg garment) (not shown) is connected to the portable pneumatic pump unit 300. This is effected by inserting a plug 130 into one of the socket formations 81 or 82. The plug 130 is connected to the product by way of three flexible plastic tubes 132 which provide fluid communication with respective cells of the pressure therapy product.

With reference to FIG. 26 there is shown at 160 a pump assembly controller comprising a data processor (or central processing unit) and an associated memory which are provided on a control printed circuit board (not shown) of the pump assembly 300. The memory has stored therein data representative of inflation/deflation control instructions associated with particular pressure therapy product types. In practice a programmable integrated circuit (PIC) device serves as both the data processor and the memory and is programmed with predetermined control protocols and instructions.

As is seen best in FIG. 24 inner conduits 131 of the connector 130 engage with the limbs 105 of the respective valve plates 100 and urge said valve plates in a rearward direction against a resilient force of the associated springs 101 thus providing fluid communication between the inflatable cells of the therapy product and the ports 14, 15, 16, 17, 18 and 19 of the static valve member 3.

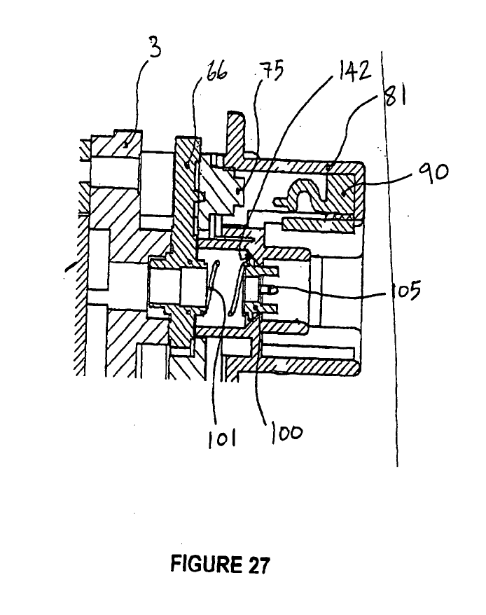

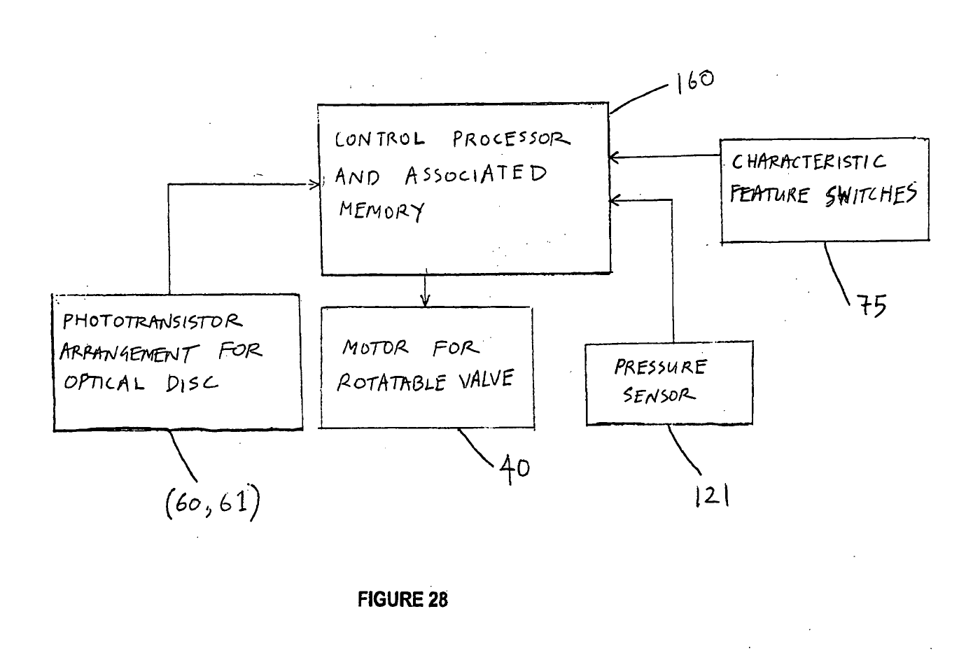

With reference to FIG. 27 when the valve plates 100 act to seal the conduits 83 (ie when a therapy product connector is not present or is not correctly positioned in a respective socket) said valve plate is seated on a chamfered shoulder 142.

An inflation/deflation cycle of a pressure therapy garment will now be described with reference in particular to FIGS. 17, 18, 19, 20 and 21.

As previously described the optical disc 41 enables the angular position of the rotatable valve member to be determined. The slot 52 is wider than the other slots 51 so as to indicate a 0° position. As the optical disc is rotated the disc 41 will selectively block light from reaching the light detecting device provided on the limb 61 and will result in a signal that is effectively a square wave. Thus the slot 52 will produce a ‘pulse’ of longer duration which is indicative of 0° position and the number of subsequent pulses produced by the narrower slots 51 will determine the angular displacement from the 0° position. Since twenty four slots are provided the optical disc 41 enables an angular resolution of 15°. Signals from the sensor arrangement 42 are sent to the PIC device 160 and the rotatable valve member is rotated to a desired angular position in response to stored information as to a current angular position and the (feedback) signal received from the sensor arrangement 42 as the optical disc is rotated.

A pressurised air inlet 110 is connected to a pneumatic pump (see FIG. 22), such that in use air is capable of being urged into the housing 48.

During a start-up procedure it is first determined whether zero, one to two therapy products are connected to the pump assembly. On start up, the PIC device 160 issues a signal to index the optical disc 41 first to the 0° and then to the 75° position, the first inflation position for the first pressure therapy product. A pulse of air of approximately 0.2 seconds duration is issued and the resulting back pressure in the rotatable valve assembly is measured by a pressure sensor 122 and logged. If a back pressure below a predetermined stored value is detected, this indicates that a product plug 130 is present in the corresponding connector socket because the air pulse is delivered past the opened valve plates 100 and into effectively an infinite volume. If a back pressure above the predetermined pressure value is detected, this indicates that there is no product present, because the closed shut off valve 100 results in the air pulse being delivered into the relatively small enclosed volume in the rotatable valve assembly.

The PIC device 160 then issues a signal to rotate the optical disc 41 to the 255° position, this is the first inflation position for the second product. The air pulse and detection procedure described above is repeated, and the PIC device determines if a therapy product is present in the second connector socket.

The PIC device 160 can now determine whether zero, one or two therapy products are present. The user is then required to manually inform the PIC device 160, by way of the user input means 301, of the type or types of therapy garment which is/are connected. For example, one or two leg garments could be attached, one or two foot garments could be attached, or a combination of two different product types could be attached.

The required pressure control data stored in the memory of the PIC device 160 for the particular therapy product type is then retrieved. Examples of various pressure control data specifications are provided hereinafter.

During normal operation, the air pulse test is repeated on each cycle. If it is found that the back pressure conditions have changed to those at start up, the PIC device 160 issues a warning on the display of the assembly 300 of ‘TUBE FAULT’, indicating that either a flexible tube 132 is kinked or that a plug 130 is dislodged. The PIC device 160 also causes an audible alarm to be issued.

FIG. 16 shows the various process steps 200 to 206 executed during the start-up procedure.

The rotatable valve member 2 is then rotated to the 75° position as shown in FIG. 17. In this position air is able to pass through one of the ports 11 and into port 14 of static valve member 3 and into port 16 of the same by virtue of the channel 21. The pressure sensor monitors the pressure of air in each of the conduits 83 which pressure measurements correspond to the pressure in the respective cells of a pressure therapy product. It is important to note that the inflation time (ie the time for which the rotatable valve member 2 is held in a particular position) is dependent on the pressure measurements and not on a predetermined time. Signals indicative of the pressure readings are sent to the PIC device 160 from the pressure sensor 122, the pressure sensor being fluidically connected to the rotatable valve assembly by an outlet port 121.

Once the predetermined pressure is reached the rotatable valve member is rotated to the 105° position shown in FIG. 18 so that one of the ports 11 is brought into alignment with the upper channel 25 and the other port 11 is brought into alignment with the lower channel 28. In such a position air is caused to inflate the cells which are in communication with the ports 15 and 18.

FIG. 19 shows the rotatable valve member in the 135° position in which the cells in communication with ports 16 and 19 of the static valve member 3 are inflated. The port 19 receives a supply of air via the channel 22.

The rotatable valve member is then rotated into the 180° position in which the blind recess 10 is brought into fluid communication with the branch channel portions 23 and 24 and the lower channel 26 and the upper channel 27. In such a position the ports 14, 15, 16, 17, 18 and 19 are brought into fluid communication with the aperture 20 via the recess 10. The aperture 20 is open to atmosphere and thus all the cells of both pressure therapy products are deflated. The deflation process is similarly controlled in response to pressure measurements as described above.

Two further positions of the rotatable valve member 2 are attainable at 30° and 210° positions respectively, curing the cycle, one of which is shown in FIG. 21. The port 12 is brought into alignment with the lower channel 28 so as to perform the tube fault test on the centrally located connection tube between a connector in the lower socket 82 and the respective pressure therapy product. If pressures above a predetermined level (as stored in the memory of the PIC device 160) are measured then this is indicated of either a kinked tube or a dislodged connector so the text TUBE FAULT is displayed to the user and an audible alarm signal is activated.

A further TUBE FAULT test is also effected for the other connection sockets. If however during the initial set-up procedure it was determined that only one product is being used then this further test is not performed.

As should now be evident one rotation through 360° of the rotatable valve member 2 results in two inflation/deflation cycles. A summary of the various angular positions of the rotatable valve is provided below.

| | |
|---|---|
| Cell 1 inflate product 1 | 75° |
| Cell 2 inflate product 1 | 105° |
| Cell 3 inflate product 1 | 135° |
| Cells deflate product 1 | 180° |
| TUBE FAULT test bottom connector | 210° |
| Cell 1 inflate product 2 | 255° |
| Cell 2 inflate product 2 | 285° |
| Cell 3 inflate product 2 | 315° |
| Cells deflate product 2 | 0° |
| TUBE FAULT test top connector | 30° |

Various pressure control data specifications of a preferred embodiment of the pneumatic pump assembly are as follows.

Performance

| Leakage | <1 mmHg per second at 160 mmHg | |
|---|---|---|
| Minimum cycle time | 45 seconds. | |
| Nominal cycle Time | 75 seconds. | |
| | The design allows for two actual cycles per | |
| | rotation of the rotor. | |
| Cell Inflation Time | Foot Garment | 10-20 seconds |
| | Calf Garment | 10-20 seconds |
| | Thigh Garment | 10-20 seconds |

| | |
|---|---|
| Cell Deflation Time | 15 seconds |
| Max. Number of Cells | 3 |
| Max. Number of Garments | 2 |

(Note Foot garments may not be mixed with other types.)

Air pressures

| | | |
|---|---|---|
| Set Pressure Range | Calf Garment | 40 to 60 mmHg. |
| | Thigh Garment | 40 to 60 mmHg |
| | Legs (one Calf + one Thigh) | 40 to 60 mmHg |
| | Foot Garment | 120 mmHg |

| | |
|---|---|
| Set Pressure | Determined by data input by user to increase or |
| | decrease a set pressure value |
| Gradient Pressure | Not applicable to foot garment |
| | cell 1 is at set pressure. |
| | cell 2 is at − 1/16 set pressure. |
| | cell 3 is at − 1/16 cell 2 set pressure |
| Initial Setting | Setting from previous session if also previous |
| | garment mode. |
| | 45 mmHg if new garment mode selected. (not foot) |
| Pressure Sensor | The circuit is calibrated without use of any pre-sets. |
| | 0 mmHg and the reference pressure of 160 mmHg only |
| | are measured. |

Low Pressure Testing

No testing during the first cycle.
Testing occurs over the complete cell inflate period.
Alarm if measured cell pressure never exceeds the threshold value during cell
inflation period.

| | |
|---|---|
| Calf Garments | Threshold pressure for cell 1 is min of 20 mmHg or ¾ set |
| | pressure. |
| | Threshold pressure for cell 2 is min of 20 mmHg or ¾ grad |
| | pressure. Threshold pressure for cell 3 is min of 20 mmHg or |
| | ¾ grad pressure. |
| Thigh Garments | Threshold pressure for cell 1 is min of 20 mmHg or ¾ set |
| | pressure. |
| | Threshold pressure for cell 2 is min of 20 mmHg or ¾ grad |
| | pressure. Threshold pressure for cell 3 is min of 20 mmHg or |
| | ¾ grad pressure. |
| Foot Garments | Threshold pressure for cell 1 is min of 20 mmHg or ¾ set |
| | pressure. |
| | Threshold pressure for cell 2 is min of 20 mmHg or ¾ grad |
| | pressure. Threshold pressure for cell 3 is min of 20 mmHg or |
| | ¾ grad pressure. |

In other embodiments alternative means of controlling the light received by the sensor device 42 are provided. For example the optical disc 41 may be replaced by a solid disc provided with light reflective portions in place of the slots 51. In another embodiment a rotatable disc may be provided with an array of angularly spaced LEDs.

As is now evident the present invention allows much greater versatility of control the inflation and deflation of a pressure therapy product. In alternative embodiments within the scope of the invention the fluid passageways of the rotatable valve member 2 and the static valve member 3 may be designed, for example, to allow for pressure therapy products with more than three cells to be controlled, or alternatively or in addition, to allow individual selective inflation or deflation of some or all of the cells of an individual pressure therapy product independently of the cells of another/other pressure therapy products.

In one embodiment of the invention the rotatable valve member and the static valve member are configured such that inflation and deflation is controlled by rotation of a single fluid passageway provided in the rotatable valve member.

The rotary control of the valve arrangement permits for various types of control including sequential, gradient sequential or peristaltic sequential.

1. Pump control assembly for a pump which is suitable for urging fluid into therapeutic inflatable cell apparatus, the pump control assembly comprising a valve arrangement comprising a rotatable valve member provided with at least one fluid passageway, the rotatable valve member being adapted to be rotated to predetermined angular positions so as to control fluid quantity in the therapeutic inflatable cell apparatus, and the pump control assembly further comprising rotatable valve member control means, which control means comprises a rotatable component which is connected to the rotatable valve member and is provided with a plurality of angularly spaced index features, the control means further comprising a radiation sensor, and in use, rotation of the rotatable component causes the index features to selectively control radiation received by the sensor.

2. The pump control assembly of claim 1 wherein the inflatable cell apparatus comprises a plurality of cells and the predetermined angular positions are indexed so that the cells can be selectively inflated and deflated.

3. The pump control assembly of claim 1 wherein the valve arrangement further comprises a static valve member, said static valve member being provided with at least one fluid passageway which is adapted to be communicable with the inflatable cell apparatus and the rotatable valve member being arranged to be rotatable with respect to the static valve member.

4. The pump control assembly of claim 3 wherein the inflatable valve member is adapted to be rotated into a position in which said at least one fluid passageway of the rotatable valve member is in fluid communication with the at least one fluid passageway of the static valve member.

5. The pump control assembly as claimed in claim 1 wherein the rotatable valve member is adapted to be rotated to predetermined angular positions so as to control fluid flow to and from the inflatable cell apparatus.

6. The pump control assembly of claim 5 wherein the rotatable valve member is provided with at least one fluid passageway for inflation of at least part of the inflatable cell apparatus and with at least one fluid passageway for deflation of at least part of the inflatable cell apparatus, and in use the rotatable valve member can be rotated to predetermined angular positions to effect at least one of inflation and deflation of the apparatus.

7. The pump control assembly of claim 6 wherein two passageways for inflation are provided which are angularly spaced by 180°.

8. The pump control assembly of claim 6 wherein the rotatable valve member is rotatable with respect to the static valve member so as to determine whether a fluid passageway of the static valve member is brought into fluid communication with either an inflation passageway or a deflation passageway of the rotatable valve member.

9. The pump control assembly of claim 3 wherein the static valve member comprises a plurality of fluid passageways, each fluid passageway being associated with a respective cell of an inflatable cell apparatus.

10. The pump control assembly of claim 3 wherein channels are formed in an outer surface in the static valve member, the channels being in fluid communication with fluid passageways of the static valve member, and said channels extending substantially laterally of the fluid passageways.

11. The pump control assembly of claim 10 wherein at least two fluid passageways are fluidically connected by a channel.

12. The pump control assembly of claim 1 wherein the control means is adapted to adjust angular position of the rotatable valve member to a desired angular position in response to a first signal relating to a current angular position, and in response to a second signal relating to sensed angular displacement of the rotatable valve member during movement to the desired angular position.

13. Pump control assembly as claimed in claim 1 comprising a radiation source and the rotatable component is interposed between the radiation source and the radiation sensor.

14. Pump control assembly as claimed in claim 1 in which each index feature is provided by a respective aperture in the rotatable component.

15. A method of controlling fluid quantity in a therapeutic inflatable cell apparatus, the method comprising rotating a rotatable valve member to predetermined angular positions so as to permit at least one of inflation of the inflatable cell apparatus and deflation of the inflatable cell apparatus, wherein control of the rotatable valve member to the predetermined angular positions is effected at least in part by way of processing a signal from a radiation sensor, and radiation received by the sensor is controlled by a rotatable component which is connected to the rotatable valve member and the rotatable component is provided with angularly spaced index features.

16. The method of claim 15 wherein the rotatable valve member is caused to be rotated in a predetermined sequence.

17. The method of claim 16 wherein the predetermined sequence causes at least one part of the therapeutic inflatable cell apparatus to be inflated and then deflated.

18. The method of claim 15 comprising rotating the rotatable valve member to bring at least one fluid passageway of the rotatable valve member into fluid communication with the inflatable cell apparatus.

19. Instructions for a data processor of a pump assembly for therapeutic inflatable cell apparatus, which, when executed by the data processor implement the method of claim 15.

20. Pump assembly for therapeutic cell apparatus comprising connection status means which means, in use, is operative to determine whether an inflatable cell therapy apparatus is connected to the pump assembly, the connection status means comprising gas issuing means, a pressure sensor, a valve and a data processor, and in use, connection and disconnection of the inflatable cell apparatus to the pump assembly determines a respective state of the valve and the pressure sensor senses gas pressure in response to the gas issued by the gas issuing means, which pressure is dependent on the instantaneous state of the valve, the pressure sensor sends a signal to the data processor indicative of the sensed pressure, and the data processor issues a signal representative of the connection status.

21. Pump assembly as claimed in claim 20 in which the valve is located so as to be engageable with a connector of an inflatable cell apparatus.

22. Pump assembly as claimed in claim 20 or claim 21 in which the valve controls communication between an internal space of the pump assembly and a space external of the pump assembly.

23. Pump assembly as claimed in claim 20 in which the valve is provided in a flow path to a connector port of the pump assembly, which connector port is adapted to receive a connector of a therapeutic cell apparatus.

24. Pump assembly as claimed in claim 20 which comprises a plurality of valves.

25. A method for determining connection status of a therapeutic inflatable cell apparatus with a pump assembly, the method comprising causing the pump to issue gas towards a connector port of the pump assembly, receiving a signal from a pressure sensor, which signal is indicative of a resulting back pressure in the pump assembly, comparing the signal to stored data and determining whether a connector of the therapeutic inflatable cell apparatus is connected to the connector port.

26. A method as claimed in claim 25 in which the signal indicative of sensed back pressure is compared to a predetermined pressure value.

27. A method as claimed in claim 26 in which if the signal is greater than the predetermined pressure then it is determined that the connector is connected.

28. A method as claimed in claim 25 which is performed as an initial procedure prior to an inflation/deflation sequence.

29. Instructions for a data processor of a pump assembly for therapeutic inflatable cell apparatus, which, when executed by the data processor implement the method of claim 25.
